(19) United States
(12) Patent Application Publication
(10) Pub. No.: US 2023/0337691 A1
(43) Pub. Date: Oct. 26, 2023

(54) PRESERVATION METHOD FOR FRESH BLUEBERRY

(71) Applicant: Zhejiang Gongshang university, Hangzhou (CN)

(72) Inventors: Jie Chen, Hangzhou (CN); Yuecheng Meng, Hangzhou (CN); Sheng Fang, Hangzhou (CN); Yanhua Li, Hangzhou (CN); Xuan Zhu, Hangzhou (CN); Yifan Liu, Hangzhou (CN); Yuhang Xue, Hangzhou (CN)

(21) Appl. No.: 17/966,039

(22) Filed: Oct. 14, 2022

(30) Foreign Application Priority Data
Apr. 20, 2022 (CN) 2022104185389

(51) Int. Cl. A23B 7/08; A23B 7/16; A23B 7/154

(52) U.S. Cl. CPC A23B 7/085; A23B 7/16; A23B 7/154; A23V 2002/00

(57) ABSTRACT

The invention discloses a preservation method for fresh blueberry, and relates to the preservation technique field of blueberry. The preservation method of the invention comprises the following steps: step (1): soaking fresh blueberries in an aqueous sodium alginate solution, taking out and drying; step (2): soaking the fresh blueberries treated in step (1) in an aqueous solution containing ε-PL and N,O carboxymethyl chitosan, taking out and drying; step 3: repeating steps (1)-(2). According to the invention, multilayer edible film is coated on the surface of blueberry, so as to extend the storage period of blueberry, thus avoiding the rot and deterioration of blueberry during storage.

### BACKGROUND OF THE INVENTION

### 1. Field of the Invention

The invention belongs to the preservation technique field of fruits, and in particular relates to a preservation method for fresh blueberry.

### 2. Description of Related Art

At present, the preservation techniques of blueberry are mainly low-temperature storage, controlled atmosphere storage, irradiation treatment and chemical preservative. For the low-temperature storage and controlled atmosphere storage techniques, their application and popularization are limited by the large volume, high price and high energy consumption of their supporting equipment; for the irradiation treatment technique, it has higher requirements for equipment, and consumers have doubts about the irradiation process; for the chemical preservative technique, it is limited in the commercial popularization of fruits and vegetables because it has potential safety hazards such as carcinogenesis, toxic residues and environmental pollution when used.

Polysaccharide edible film, a layer of mesh structural film, is formed through the interaction of intramolecular and intermolecular hydrogen bonds by taking polysaccharide with high molecular weight as the film-forming substrate. Natural polysaccharide is one of the ideal edible packaging materials because of its abundant sources, degradability and renewability. The polysaccharide edible film is chemically stable, and has excellent antioxidative function because of its ordered hydrogen bond mesh. Liu Yaping et al. explored the effect of chitosan on the textures and qualities of cherry and tomato, and found that the cherry and tomato treated with 1.0% chitosan had high cohesion in the early stage of storage, indicating that chitosan treatment had a good preservation effect on the textures and qualities of their fruits. Zhuang Rongyu et al. explored the effect of hydroxypropyl methylcellulose edible film on the firmness and color of tomato stored at 20° C., and found that using hydroxypropyl methylcellulose edible film could delay the softening of tomato, delay the post-harvest ripening of tomato and extend the shelf life of tomato. Polysaccharide contains a large number of hydrophilic groups such as hydroxyl groups and has strong water solubility, so the polysaccharide film also has some problems such as poor moisture resistance and water resistance. The single-substrate film inevitably has some shortcomings in some properties, while the compound-substrate film can be improved in property and its application scope can be expanded by using the physical and chemical properties of different films and the synergistic effect among the different films.

The lipid edible film, with hydrophobic structure and low polarity, can condense and exclude polar molecules in the presence of water, so that it has a good moisture res stance on the fruits and vegetables with high transpiration rates. Anderson et al. explored the preservation effect of different concentrations of beeswax/hydroxypropyl methylcellulose edible film on pomegranate, and found that compared with the pomegranate fruit in control group, the weight loss of the pomegranate fruit coated with the lipid edible film was reduced, the firmness was kept and the shelf life was extended for 6 days, so that a certain preservation effect was realized; however, lipid edible film is limited to some extent because it is easily oxidized to produce bad flavor, and has low light transmittance, poor mechanical strength and waxy taste.

### SUMMARY OF THE INVENTION

Given the shortcomings of the prior art, the invention provides a preservation method for fresh blueberry, so as to effectively inhibit the growth of bacteria and extend the shelf life of fresh blueberry.

The preservation method for fresh blueberry in the invention comprises the following steps:
(1) soaking fresh blueberries in an aqueous sodium alginate solution with concentration of 1.5 wt %, taking out and drying;
(2) soaking the fresh blueberries treated in step (1) in an aqueous solution containing ε-PL and N,O carboxymethyl chitosan, taking out and drying;
(3) repeating steps (1)-(2).

For a preferred embodiment, the soaking time and soaking temperature in step (1) are 2 min and room temperature respectively.

For a preferred embodiment, the aqueous sodium alginate solution in step (1) also contains glycerol, and the concentration of the glycerol is 0.5 wt % in the aqueous sodium alginate solution.

For a preferred embodiment, the mass concentrations of ε-PL and N,O carboxymethyl chitosan are both 4 wt % in the aqueous solution containing ε-PL and N,O carboxymethyl chitosan in step (2).

For a preferred embodiment, the soaking time and soaking temperature in step (2) are 2 min and room temperature respectively.

Compared with the prior art, the invention has the following beneficial effects:

The preservation method for fresh blueberry in the invention can reduce the rot rate of blueberry, inhibit the growth of bacteria, and significantly extend the shelf life of blueberry. The layer-by-layer self-assembled ε-PL-N,O carboxymethyl chitosan—sodium alginate edible film in the invention has strong antibacterial property.

### BRIEF DESCRIPTION OF THE DRAWINGS

FIG. 1 shows the comparison of weight loss rate of blueberry during storage;

FIG. 2 shows the effects of different treatments on the rot rate of blueberry;

FIG. 3 shows the effects of different treatments on the firmness of blueberry;

FIG. 4 shows the effects of different treatments on the cell membrane permeability of blueberry;

FIG. 5 shows the effects of different treatments on the total phenols content of blueberry;

FIG. 6 shows the effects of different treatments on the total flavonoids content of blueberry;

FIG. 7 shows the effects of different treatments on the anthocyanins content of blueberry;

FIG. 8 shows the effects of different treatments on the malondialdehyde (MDA) content of blueberry;

FIG. 9 and FIG. 10 show the effects of different treatments on the sensory quality of blueberry.

### DETAILED DESCRIPTION OF THE PREFERRED EMBODIMENTS

The invention will be further described with reference to the following specific embodiments.

### Embodiment 1

A preservation method for fresh blueberry comprises the following steps:
(1) soaking fresh blueberries in an aqueous sodium alginate solution with concentration of 1.5 wt % for 2 min (at room temperature), taking out and drying, wherein the aqueous sodium alginate solution also contains glycerol, and the concentration of the glycerol is 0.5 wt % in the aqueous sodium alginate solution;
(2) soaking the fresh blueberries treated in step (1) in an aqueous solution containing ε-PL and N,O carboxymethyl chitosan for 2 min (at room temperature), taking out and drying, wherein the mass concentrations of ε-PL and N,O carboxymethyl chitosan are both 4 wt % in the aqueous solution containing ε-PL and N,O carboxymethyl chitosan;
(3) repeating steps (1)-(2) to obtain Group LBL2 of blueberries with two-layer self-assembled sodium alginate/ε-PL edible film.

### Comparative Example 1

A preservation method for fresh blueberry comprises the following step:
soaking fresh blueberries in an aqueous sodium alginate solution with concentration of 1.5 wt % for 2 min (at room temperature), taking out and drying to obtain Group SA of blueberries, wherein the aqueous sodium alginate solution also contains glycerol, and the concentration of the glycerol is 0.5 wt % in the aqueous sodium alginate solution.

### Comparative Example 2

A preservation method for fresh blueberry comprises the following step:
soaking fresh blueberries in an aqueous solution containing ε-PL and N,O carboxymethyl chitosan for 2 min (at room temperature), taking out and drying to obtain Group ε-PL of blueberries, wherein the mass concentrations of ε-PL and N,O carboxymethyl chitosan are both 4 wt % in the aqueous solution containing ε-PL and N,O carboxymethyl chitosan.

### Comparative Example 3

Soaking blueberries in sterile water for 2 min, taking out and drying to obtain Group CK of blueberries.

The blueberries treated in Embodiment 1 and Comparative Examples 1-3 were observed, analyzed and detected, as shown in FIGS. 1-10.

1. Comparison of Weight Loss Rate of Blueberry During Storage

As can be seen from FIG. 1, compared with Group CK of blueberries, the three treated blueberries showed a lower weight loss rate during the whole storage. During five days of storage, the weight loss rates of four groups of blueberries increased slowly in the first two days, and increased rapidly from the third day. There was a significant difference between Group CK and film-coating groups on the first day (P<0.05); there was no significant difference between Group CK and Group 2 (Group ε-PL) on the first day, but there was a significant difference from the second day (P<0.05); there was no significant difference between Group 1 (Group SA) and Group 3 (Group LBL2) in the first four days, but there was a significant difference on the fifth day (P<0.05). On the fifth day, the weight loss rate of blueberries in Group CK was 25.04%, while the weight loss rates of blueberries in Group 1, Group 2 and Group 3 were 17.36%, 20.02% and 15.01% respectively, showing that the weight loss rate of blueberries in Group LBL2 was the lowest, and there were significant differences between Group CK and the three treated groups respectively (P<0.01).

Weight loss is the result of water loss and nutrient consumption of fruits during storage. During the whole storage, the weight loss rates of blueberries in the three treated groups were always lower than the weight loss rate of blueberries in Group CK, indicating that coated film can slow down the weight loss of blueberry, specifically, the coated film can wrap the surface of blueberry to reduce the water exchange between blueberry and the outside world, keep a slow weight loss rate of blueberry, and reduce the weight loss of blueberry during storage, so as to keep fresh and tender taste of blueberry. Group LBL2 can slow down the respiration of blueberry because of its self-assembled film structure, so its weight loss rate is lower than the weight loss rates of Group SA, Group ε-PL and Group CK.

2. Effects of Different Treatments on Rot Rate of Blueberry

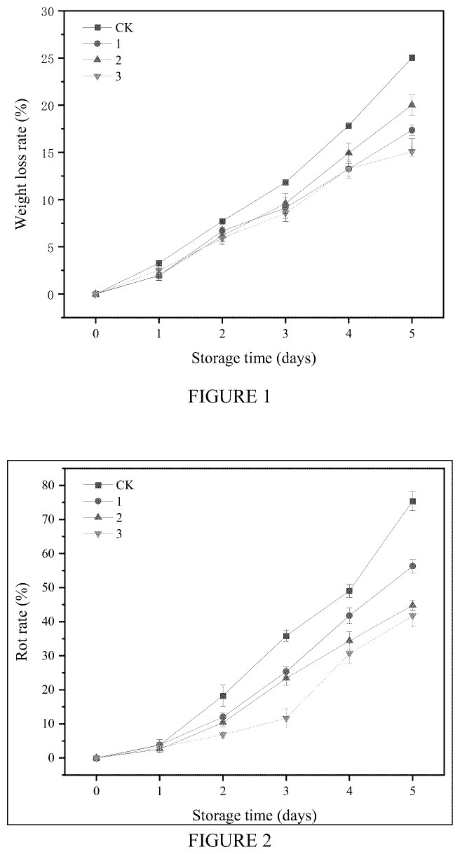

As can be seen from FIG. 2, the rot rate of blueberry showed an increase trend during storage, and the rot rates of blueberries in the three treated groups were lower than the rot rate of blueberries in Group CK during the whole storage. On the second day, there was a significant difference in the rot rate between Group CK and the three treated groups (P<0.05). On the fifth day, there was a very significant difference between Group CK and the three treated groups (P<0.01), specifically, the rot rate of Group CK was 75.40%, while the rot rates of Group 1, Group 2 and Group 3 were 56.33%, 44.80% and 41.74% respectively, indicating that the rot rate of Group LBL2 was the lowest.

Rot rate is one of the most intuitive indexes to measure the storage quality of fruit. ε-PL has good broad-spectrum antibacterial effect, and SA can isolate external microorganisms after forming film, so there was no significant difference between Group ε-PL and Group SA in the first three days; on the third day, the rot rates of Group ε-PL and Group SA were 25.33% and 23.39%, respectively; however, during the later storage, due to the existence of original colonies on the surface of blueberry, microorganisms proliferating in large numbers caused the skin of blueberry to be broken. The experimental results showed that the rot rate of blueberries in Group ε-PL was significantly lower than that of blueberries in Group SA (P<0.05); as time goes by, Group LBL2 (Group 3) had a better effect than Group SA and Group ε-PL, indicating that the single SA film is poor in uniformity and is thinner than LBL2 film, and Group ε-PL cannot maintaine the mechanical strength of blueberry fruit skin due to lack of film structure, so that the effects of delaying rot in Group SA and Group ε-PL were not as good as LBL2 film during the middle and late storage.

3. Effects of Different Treatments on the Firmness of Blueberry

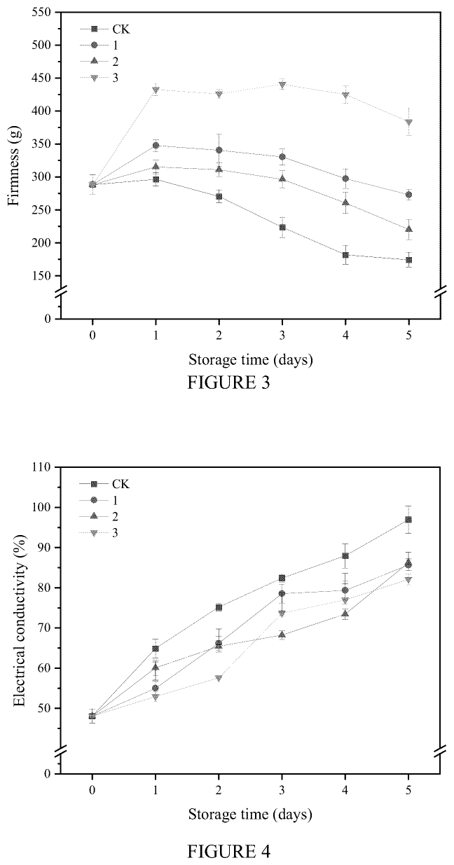

As can be seen from FIG. 3, the firmness of blueberry showed a trend of first increase and then decrease during storage, wherein Group CK had the smallest increase and the largest decrease; the blueberries in Group CK had lower firmness than those in the three treated groups. There was a significant difference between Group CK and the three treated groups on the first day (P<0.05), and there was a very significant difference between Group CK and the three treated groups on the second day (P<0.01); during the whole storage, Group ε-PL was significantly different from Group SA and Group LBL2 (P<0.05), and its firmness was always lower. On the fifth day, the firmness of Group CK was 174.38 g, while the firmnesses of Group 1, Group 2 and Group 3 were 273.02 g, 220.24 g and 383.76 g respectively, indicating that the firmness of Group LBL2 was the highest.

4. Effects of Different Treatments on Cell Membrane Permeability of Blueberry

As can be seen from FIG. 4, during storage, the electrical conductivity of blueberry keept increasing, while Group CK showed stable increase, and the film-coating groups showed unstable increase. On the first day, Group CK showed significant difference from Group 1, Group 2 and Group 3 (P<0.05); on the second day, Group CK showed very significant difference from the three treated groups (P<0.01), wherein the electrical conductivity of Group 3 was lower; on the fifth day, the electrical conductivity of Group CK was 96.05%, while the electrical conductivities of Group 1, Group 2 and Group 3 were 85.64%, 86.23% and 82.10% respectively, wherein the electrical conductivity of Group 3 was the lowest.

The cell membrane permeability not only reflects the integrity and stability of fruit cell membrane, but also reflects the damage degree of cell to a certain extent. Electrical conductivity is an important index to measure cell membrane permeability, specifically, the higher the electrical conductivity, the more serious the damage of cell membrane is. Compared with Group CK, Group 1, Group 2 and Group 3 could significantly inhibit the increase of cell membrane permeability (P<0.05) to be conducive to maintaining the integrity of cell membrane. The electrical conductivity of Group ε-PL increased rapidly during the late storage. From the whole storage process, self-assembled group (Group LBL2) had a better protective effect on cell membrane.

5. Effects of Different Treatments on the Total Phenols Content of Blueberry

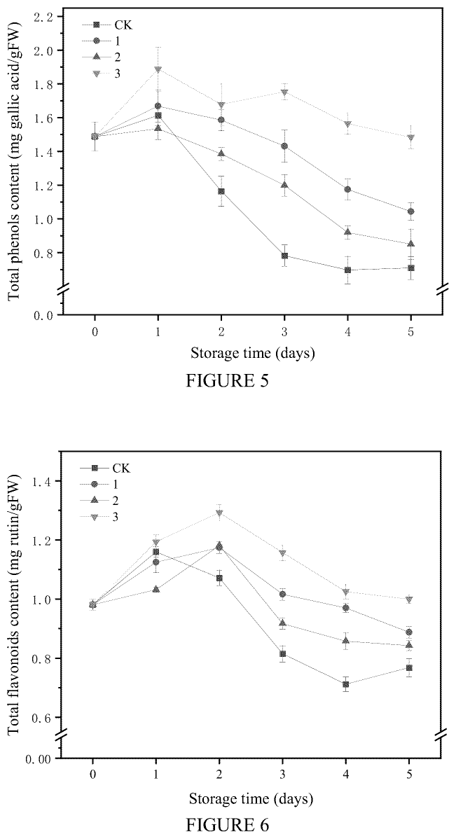

As can be seen from FIG. 5, during the whole storage of blueberry, the total phenols content of blueberry showed an overall trend of increase first and then decrease. The total phenols content of blueberries in Group CK reached the peak on the first day, i.e., 1.6138 mg/g, 8.45% higher than that on the 0th day, in the later storage, the total phenols content began to decrease rapidly, and reached the lowest point on the fourth day, i.e., 0.6973 mg/g, 53.14% lower that on the 0th day. On the second day, there was a very significant difference between Group CK and the three treated groups (P<0.01). The total phenols content of Group 3 showed a fluctuant decrease trend, but the total phenols content of Group 3 was higher than the total phenols contents of other three groups in the same period. On the fifth day, the total phenols content of Group CK was 0.7096 mg/g, while the total phenols contents of Group 1, Group 2 and Group 3 were 1.0440 mg/g, 0.8506 mg/g and 1.4842 mg/g, respectively, wherein the total phenols content of Group 3 was the highest.

Phenols, the main antioxidant ingredients in vegetables and fruits, can reflect the antioxidant activity of fruits. At the early stage of storage, the total phenols content increased, which was related to the postharvest ripening of blueberry fruit, specifically, the accumulation of synthesized total phenols increased the total phenols content after the postharvest ripening of blueberry fruits. Group ε-PL increased slowly, indicating that ε-PL had little stimulation to blueberry fruit and could delay the ripening of blueberry fruit; in contrast, Group SA had higher total phenols content than Group ε-PL in the same period, with the possible reasons as follows: SA film had good mechanical strength to protect the cell wall of fruit and thus slow down the consumption of total phenols, and SA could stimulate the accumulation of phenols. The peak of Group LBL2 was obviously higher than that of the other three groups, indicating that layer-by-layer self-assembly technology could promote the synthesis of total phenols; during storage, the reason why fluctuation occurred was that the self-repairability of LBL film made itself keep the good mechanical property so as to better delay the loss of total phenols content of blueberry and keep better functionality of blueberry. With the extendation of storage time, more juice flowed due to the damage of the cell wall of blueberry, and the consumption quantity is greater than the synthesis quantity, so that the total phenols content continuously decreased, but the total phenols contents of the three treated groups were always higher than the total phenols content of Group CK in the same period.

6. Effects of Different Treatments on Total Flavonoids Content of Blueberry

As can be seen from FIG. 6, compared with the three treated groups, the peak of flavonoids content of Group CK occurred on the first day, i.e., 1.1600 mg/g, 18.27% higher than that on the 0th day; during the later storage, the flavonoids content of Group CK began to decrease from the second day, while the flavonoids contents of the three treated groups began to decrease on the third day. On the first day, the flavonoids contents of Group CK, Group 1 and Group 3 increased rapidly, but there was no significant difference between Group CK and Group 1 and between Group CK and Group 3 (P>0.05), while there was significant difference between Group CK and Group 2 (P<0.05). From the second day, there were significant differences between Group CK and Group SA, between Group CK and Group ε-PL, and between Group CK and Group LBL2 (P<0.05). There was significant difference between Group SA and Group LBL2 during the whole storage (P>0.05). On the fifth day, the flavonoids content of Group CK was 0.7681 mg/g, while the flavonoids contents of Group SA, Group ε-PL and Group LBL2 were 0.8878 mg/g, 0.8427 mg/g and 1.0002 mg/g, respectively, indicating that the flavonoids content of Group 3 was the highest.

Flavonoids, as a kind of secondary metabolites in plants, often exist in fruit in free or combined state; flavonoids are closely related to plant disease resistance. At the early stage of storage, the flavonoids content of blueberry increased, indicating that the synthesis rate of flavonoids was higher than the decomposition rate due to postharvest ripening of blueberry, thus showing that the flavonoids content increased. The flavonoids content of Group CK reached the peak on the first day, and began to decrease on the second day, while the three treated groups remained at a high level on the second day and decreased on the third day; the two groups of layer-by-layer self-assembled blueberries peaked on the third day, and their flavonoids contents were always higher than the flavonoids content of single film-coating group, indicating that LBL could better delay the ripening of blueberry and promote the increase of flavonoids content of blueberry during storage.

7. Effects of Different Treatments on Anthocyanins Content of Blueberry

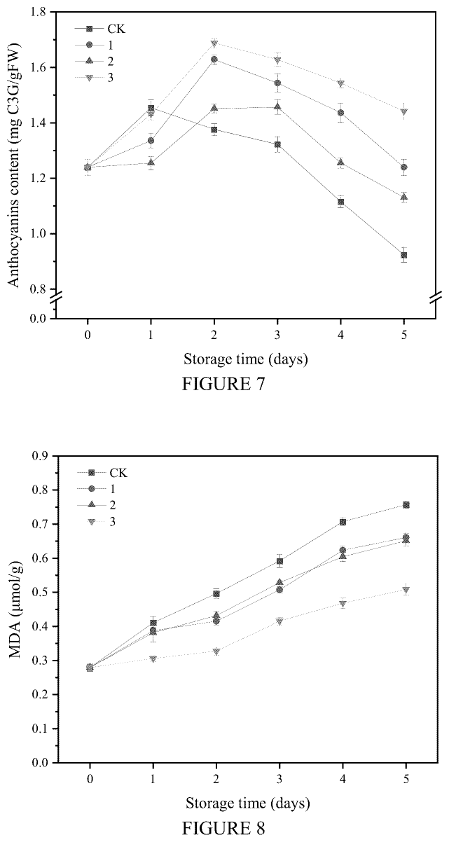

As can be seen from FIG. 7, during storage, compared with the three treated groups, the peak of anthocyanins content of Group CK occurred on the first day, i.e., 1.4546 mg/g, significantly different from the anthocyanins contents of Group 1 and Group 2 (P<0.05). On the second day, there were significant differences between Group CK and the other three groups (P<0.05). The anthocyanins content of Group CK on the fifth day was 25.49% lower than that on the 0th day. On the fifth day, the anthocyanins content of Group CK was 0.9236 mg/g, while the anthocyanins contents of Group 1, Group 2 and Group 3 were 1.2395 mg/g, 1.1311 mg/g and 1.4419 mg/g, respectively, wherein the anthocyanins content of Group 3 was the highest.

At the early stage of storage, the anthocyanins content of blueberry showed an overall increase trend first due to the postharvest ripening of blueberry, and the peaks of anthocyanins contents of the three treated groups were higher possibly due to abiotic stress factors. The peak of anthocyanins content of layer-by-layer self-assembled film-coating group was higher than that of single treated Group 1 and Group 2, and the peak occurred later, indicating that coated film could delay the ripening of blueberry more effectively, possibly because LBL film had good mechanical strength to delay the senescence and rot of blueberry.

8. Effects of Different Treatments on Malondialdehyde (MDA) Content of Blueberry

As can be seen from FIG. 8, during storage, the MDA content of blueberry kept increasing. The MDA content of Group CK was significantly different from that of the three treated groups on the second day (P<0.05). During storage, the MDA content of Group LBL2 was lower than that of other three groups, and there were significant differences between Group LBL2 and other three groups on the second, third and fourth days (P<0.05). On the fifth day, the MDA content of Group CK was 0.76 μmol/g, and the MDA contents of Group 1, Group 2 and Group 3 were 0.66 μmol/g, 0.65 μmol/g and 0.51 μmol/g, respectively, wherein the MDA of Group 3 was the lowest.

Lipid peroxidation often occurs when fruits and vegetables suffer from adversity stresses like diseases or other damages during their ripening and senescence, and malondialdehyde (MDA) is one of its main products. MDA is usually used as an index of lipid peroxidation to reflect the degree of lipid peroxidation in cell membrane. As shown in the figure, the increase of MDA content of Group CK was higher than that of the three treated groups during the whole storage, and the increase was obvious; the increase of MDA content of Group LBL2 was slight, and was kept low in the first two days, indicating that LBL treatment could effectively inhibit the accumulation of MDA and be conductive to extending the storage period of blueberry.

9. Effects of Different Treatments on Sensory Quality of Blueberry

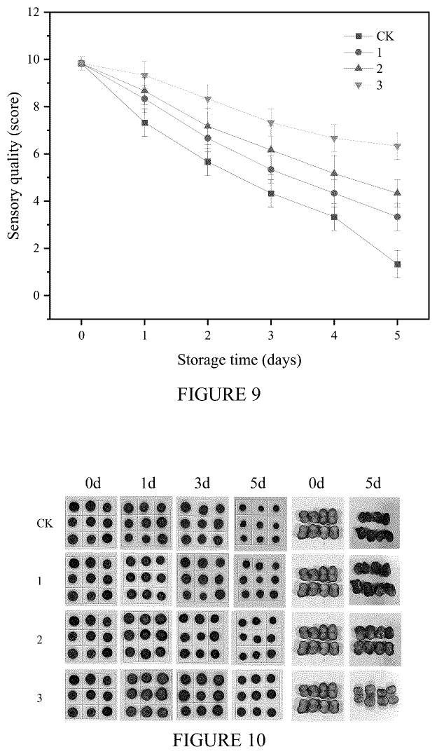

As can be seen from FIG. 9 and FIG. 10, the sensory quality of blueberry was gradually decreasing during storage. The sensory quality of Group CK was always worse than that of the other three groups during storage, and there was significant difference between Group CK and the other three groups on the first day (P<0.05). At the end of storage, the sensory quality score of Group CK was 1.33, while the sensory quality scores of Group 1, Group 2 and Group 3 were 3.33, 4.33 and 6.33, respectively, wherein the score of Group 3 was the highest. During storage, Group CK suffered from more water loss, serious shrinkage, pulp color darkening and pulp rot. In the experiment, it could be found that the blueberries in Group CK began to shrink on the third day, the fruits became soft, and some blueberries had visible mildew, so that the sensory quality score was less than 5 points; LBL-treated Group 3 had relatively full fruit, better firmness and better pulp quality on the fifth day, so that the sensory quality score was more than 5 points. Group LBL2 had a good blueberry quality because of its coated film inhibiting the respiration of fruits and microorganisms and keeping the antibacterial activity of ε-PL.

What is claimed is:

1. A preservation method for fresh blueberry comprises the following steps:
(1) soaking fresh blueberries in an aqueous sodium alginate solution with concentration of 1.5 wt %, taking out and drying;
(2) soaking the fresh blueberries treated in step (1) in an aqueous solution containing ε-PL and N,O carboxymethyl chitosan, taking out and drying;
(3) repeating steps (1)-(2).

2. The preservation method for fresh blueberry according to claim 1 is characterized in that the soaking time and soaking temperature in step (1) are 2 min and room temperature respectively.

3. The preservation method for fresh blueberry according to claim 1 is characterized in that the aqueous sodium alginate solution in step (1) also contains glycerol, and the concentration of the glycerol is 0.5 wt % in the aqueous sodium alginate solution.

4. The preservation method for fresh blueberry according to claim 1 is characterized in that the mass concentrations of ε-PL and N,O carboxymethyl chitosan are both 4.0 wt % in the aqueous solution containing ε-PL and N,O carboxymethyl chitosan in step (2).

5. The preservation method for fresh blueberry according to claim 4 is characterized in that the soaking time and soaking temperature in step (2) are 2 min and room temperature respectively.
